(19) United States
(12) Patent Application Publication
(10) Pub. No.: US 2025/0166873 A1
(43) Pub. Date: May 22, 2025

(54) THUNDER PROTECTION APPARATUS AND THUNDER PROTECTION METHOD

(71) Applicant: NIPPON TELEGRAPH AND TELEPHONE CORPORATION, Tokyo (JP)

(72) Inventors: Naomichi NAKAMURA, Tokyo (JP); Naoki HANAOKA, Tokyo (JP); Yuji HIGUCHI, Tokyo (JP); Toru TANAKA, Tokyo (JP)

(73) Assignee: NIPPON TELEGRAPH AND TELEPHONE CORPORATION, Tokyo (JP)

(21) Appl. No.: 18/841,342

(22) PCT Filed: Feb. 28, 2022
(86) PCT No.: PCT/JP2022/008394

§ 371 Date: Aug. 23, 2024

(51) Int. Cl. H01C 7/12

(52) U.S. Cl. CPC H01C 7/12

(57) ABSTRACT

A lightning protection device for protecting a DC power supply device from a lightning surge current includes: a positive-electrode-side lightning arrester connected between a positive-electrode-side power cable of the DC power supply device and a ground point; and a negative-electrode-side lightning arrester connected between a negative-electrode-side power cable of the DC power supply device and the ground point, in which a difference in operating voltage between the positive-electrode-side lightning arrester and the negative-electrode-side lightning arrester is equal to or more than a reference value.

### TECHNICAL FIELD

The present invention relates to a lightning protection device and a lightning protection method.

### BACKGROUND ART

There have been developed countermeasures against a lightning surge that has entered into a power supply device due to a lightning strike. As a countermeasure against a lightning surge of a DC power supply device (e.g. DC/DC converter), it is known to install a surge protective device (SPD) such as a zinc oxide varistor (hereinafter, varistor) on the output side (into which a lightning surge enters) of the DC power supply device. For example, when varistors disclosed in Non Patent Literature 1 are installed between a positive electrode of the DC power supply device and the ground and between a negative electrode thereof and the ground, it is possible to release a lightning surge that has entered from a cable to the ground via the varistors.

### CITATION LIST

### Non Patent Literature

Non Patent Literature 1: Varistors (ZNR Surge Absorber), https://industrial.panasonic.com/jp/products/pt/surge-components

### SUMMARY OF INVENTION

### Technical Problem

The DC power supply device has the following problems. As a countermeasure against a lightning surge that has entered from the output side of the DC power supply device, the varistors are installed between the positive electrode on the output side of the DC power supply device and the ground and between the negative electrode and the ground in an internal circuit of the DC power supply device. This makes it possible to release a lightning surge that has entered into the positive electrode, a lightning surge that has entered into the negative electrode, a lightning surge that has simultaneously entered into the positive electrode and the negative electrode, and the like to the ground. However, in a case where an electronic element or electronic circuit having an action (rectification action) of causing a current to flow only in a certain direction, such as a diode, is provided between lines (between the positive electrode and the negative electrode), the varistor installed between the negative electrode and the ground does not operate, and the lightning surge that has entered into the negative electrode flows to the positive electrode via the diode, whereas the varistor installed between the positive electrode and the ground operates, and the lightning surge that has entered into the negative electrode flows to the ground. At this time, the diode may be destroyed by the lightning surge current, and thus the device may fail.

An object of the disclosed technique is to appropriately release a lightning surge to the ground even in a case where an electronic element or electronic circuit having a rectification action is provided between lines of a DC power supply device.

### Solution to Problem

The disclosed technique is a lightning protection device for protecting a DC power supply device from a lightning surge current, the lightning protection device including: a positive-electrode-side lightning arrester connected between a positive-electrode-side power cable of the DC power supply device and a ground point; and a negative-electrode-side lightning arrester connected between a negative-electrode-side power cable of the DC power supply device and the ground point, in which a difference in operating voltage between the positive-electrode-side lightning arrester and the negative-electrode-side lightning arrester is equal to or more than a reference value.

### Advantageous Effects of Invention

It is possible to appropriately release a lightning surge to the ground even in a case where an electronic element or electronic circuit having a rectification action is provided between lines of a DC power supply device.

### BRIEF DESCRIPTION OF DRAWINGS

FIG. 1 illustrates an example of a configuration of a conventional lightning protection device.

FIG. 2 illustrates a case where a lightning surge enters into a DC power supply device including an electronic element or electronic circuit having a rectification action.

FIG. 3 illustrates a case where a lightning surge enters only into a positive electrode of a DC power supply device including an electronic element or electronic circuit having a rectification action.

FIG. 4 is a first diagram illustrating a case where a lightning surge enters only into a negative electrode of a DC power supply device including an electronic element or electronic circuit having a rectification action.

FIG. 5 is a second diagram illustrating a case where a lightning surge enters only into a negative electrode of a DC power supply device including an electronic element or electronic circuit having a rectification action.

FIG. 6 is a third diagram illustrating a case where a lightning surge enters only into a negative electrode of a DC power supply device including an electronic element or electronic circuit having a rectification action.

FIG. 7 is a fourth diagram illustrating a case where a lightning surge enters only into a negative electrode of a DC power supply device including an electronic element or electronic circuit having a rectification action.

FIG. 8 illustrates a method of securing a maximum allowable circuit voltage between lines.

FIG. 9 illustrates a method of calculating a difference in operating voltage.

FIG. 10 is a first diagram illustrating an example of a configuration of a lightning protection device according to the present embodiment.

FIG. 11 is a second diagram illustrating an example of the configuration of the lightning protection device according to the present embodiment.

FIG. 12 is a third diagram illustrating an example of the configuration of the lightning protection device according to the present embodiment.

### DESCRIPTION OF EMBODIMENTS

Hereinafter, an embodiment of the present invention (present embodiment) will be described with reference to the drawings. The embodiment described below is merely an example, and an embodiment to which the present invention is applied is not limited to the embodiment described below. Before description of the technique according to the present embodiment, a conventional technology related to the present embodiment and problems thereof will be described first.

### (Conventional Technology)

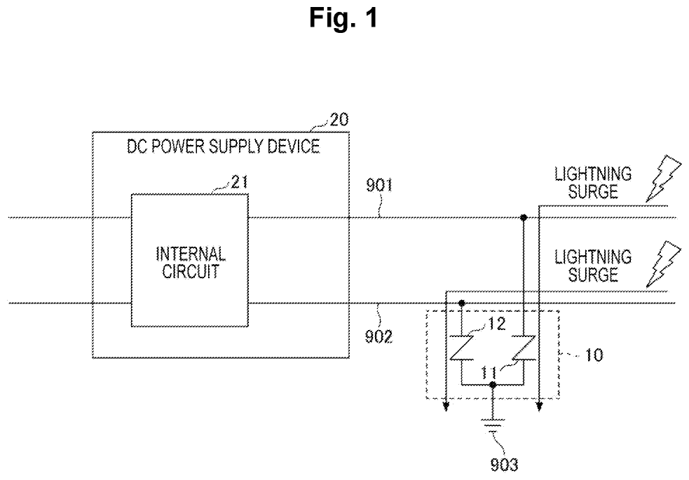

FIG. 1 illustrates an example of a configuration of a conventional lightning protection device. A lightning protection device 10 protects a DC power supply device 20 (and an internal circuit 21 thereof) from a lightning surge. The lightning protection device 10 includes a lightning arrester element such as a zinc oxide varistor or a lightning arrester circuit (hereinafter, varistor). Specifically, the lightning protection device 10 includes a positive electrode varistor 11 and a negative electrode varistor 12.

The positive electrode varistor 11 is connected between a positive-electrode-side power cable 901 of the DC power supply device 20 and a ground point 903. The positive electrode varistor 11 is an example of a positive-electrode-side lightning arrester (lightning arrester element or lightning arrester circuit). The negative electrode varistor 12 is connected between a negative-electrode-side power cable 902 of the DC power supply device 20 and the ground point 903. The negative electrode varistor 12 is an example of a negative-electrode-side lightning arrester (lightning arrester element or lightning arrester circuit).

In the configuration of FIG. 1, when a lightning surge current is generated due to a lightning strike or the like, the lightning surge current can be released to the ground point 903 via the positive electrode varistor 11 and the negative electrode varistor 12.

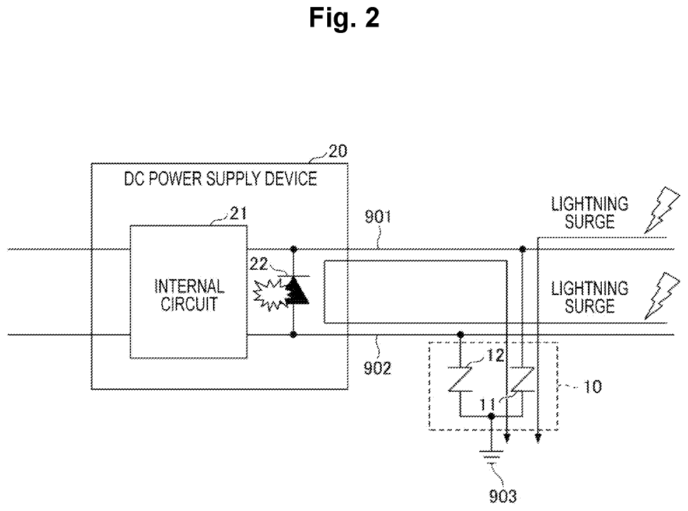

FIG. 2 illustrates a case where a lightning surge enters into the DC power supply device including an electronic element or electronic circuit having a rectification action. The DC power supply device 20 of FIG. 2 includes a diode 22. The diode 22 is an example of the electronic element or electronic circuit having the rectification action.

In the configuration of FIG. 2, when a lightning surge current is generated due to a lightning strike or the like, no voltage is applied to the negative electrode varistor 12 due to the diode 22, and the lightning surge current that has entered the negative electrode may flow to the positive electrode via the diode 22 and flow to the ground point 903 via the positive electrode varistor 11. Therefore, the diode 22 may be broken by the lightning surge current, and the DC power supply device 20 may fail.

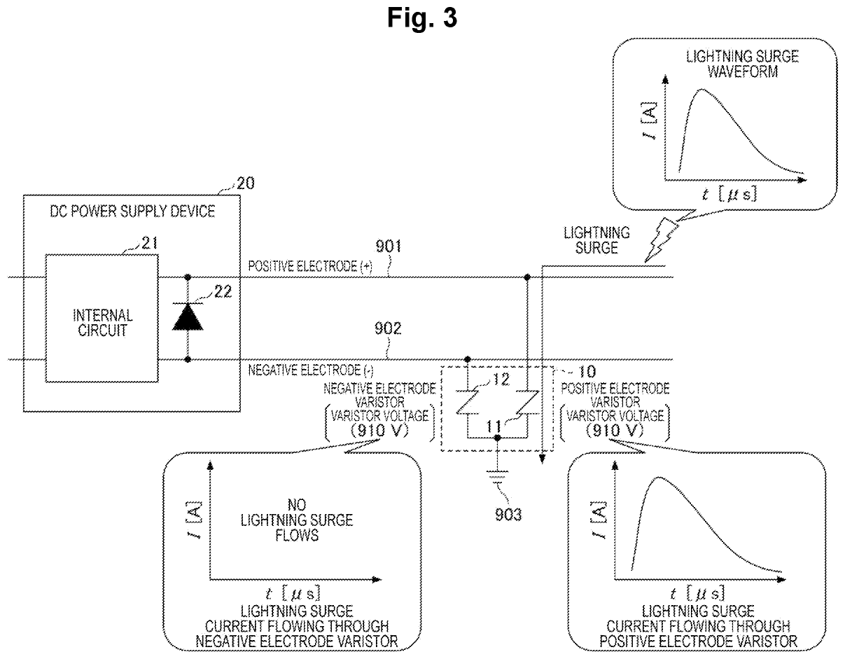

FIG. 3 illustrates a case where a lightning surge enters only into the positive electrode of the DC power supply device including the electronic element or electronic circuit having the rectification action. In a case where a lightning surge enters only into the positive electrode, no lightning surge current flows into the diode 22. Thus, the positive electrode varistor 11 normally operates, and the DC power supply device 20 does not fail.

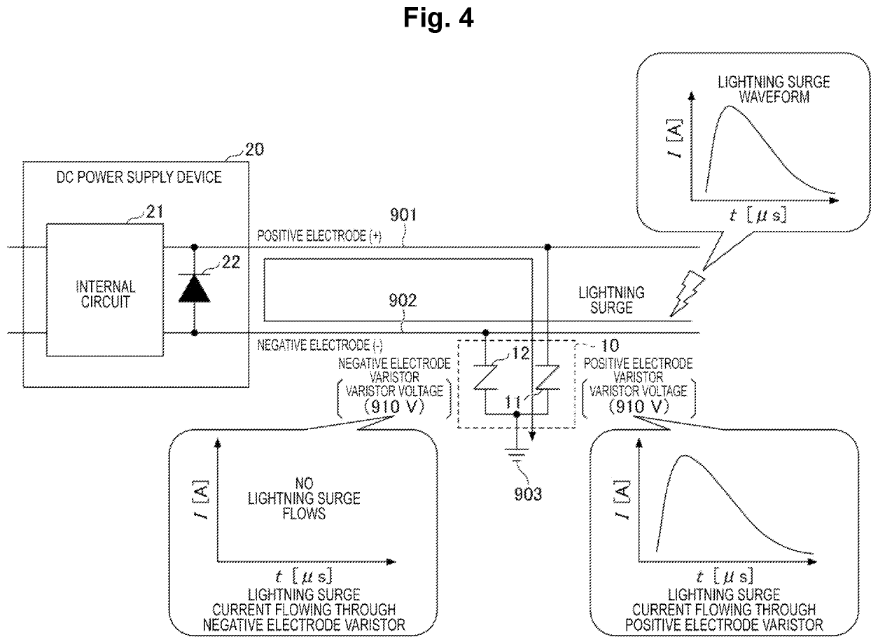

FIG. 4 is a first diagram illustrating a case where a lightning surge enters only into the negative electrode of the DC power supply device including the electronic element or electronic circuit having the rectification action. In a case where the lightning surge enters only into the negative electrode, a lightning surge current flows into the diode 22, and no voltage is applied to the negative electrode varistor 12 (the varistor does not operate). Thus, the diode 22 may be broken, and the DC power supply device 20 may fail.

FIG. 4 illustrates a lightning surge current flowing through each varistor in a case where the positive electrode varistor 11 and the negative electrode varistor 12 have substantially the same operating voltage (e.g. both the varistors have 910 V). In this case, no lightning surge current flows through the negative electrode varistor 12, and most of the generated lightning surge current flows through the positive electrode varistor 11.

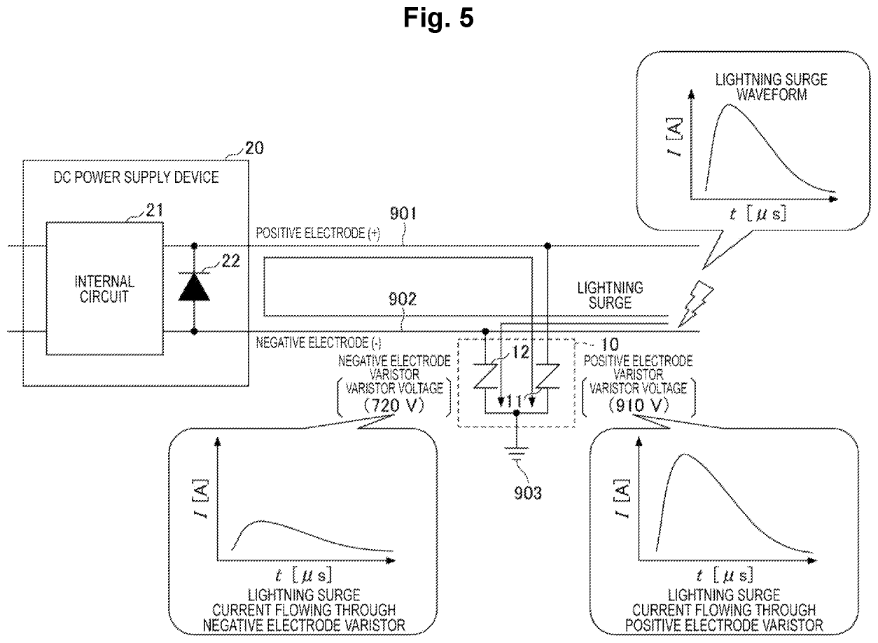

FIG. 5 is a second diagram illustrating a case where a lightning surge enters only into the negative electrode of the DC power supply device including the electronic element or electronic circuit having the rectification action. FIG. 5 illustrates a lightning surge current flowing through each varistor in a case where the operating voltage of the positive electrode varistor 11 and the operating voltage of the negative electrode varistor 12 have a slight difference (e.g. the operating voltage of the positive electrode varistor 11 is 910 V, and the operating voltage of the negative electrode varistor 12 is 790 V). When a difference is made between the operating voltages, the negative electrode varistor 12 easily operates. This makes it possible to cause the entered lightning surge to flow not only to the positive electrode but also to the negative electrode.

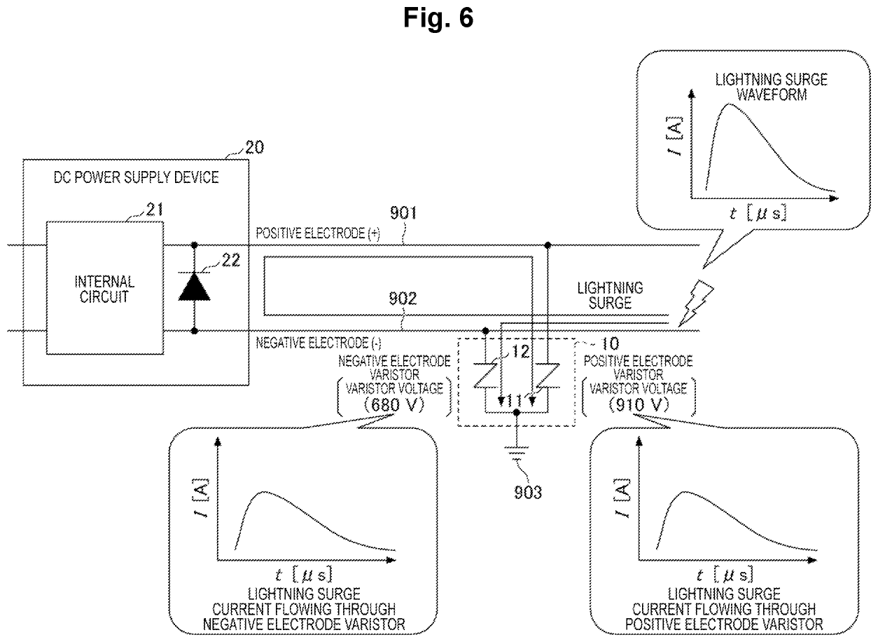

FIG. 6 is a third diagram illustrating a case where a lightning surge enters only into the negative electrode of the DC power supply device including the electronic element or electronic circuit having the rectification action. FIG. 6 illustrates a lightning surge current flowing through each varistor in a case where the operating voltage of the positive electrode varistor 11 and the operating voltage of the negative electrode varistor 12 have a relatively large difference (e.g. the operating voltage of the positive electrode varistor 11 is 910 V, and the operating voltage of the negative electrode varistor 12 is 680 V). When a relatively large difference is made between the operating voltages, the negative electrode varistor 12 further easily operates. This makes it possible to cause the entered lightning surge to flow substantially equally to the positive electrode and the negative electrode. Therefore, a lightning surge current flowing through the diode 22 is reduced, which makes it possible to prevent failure of the DC power supply device 20.

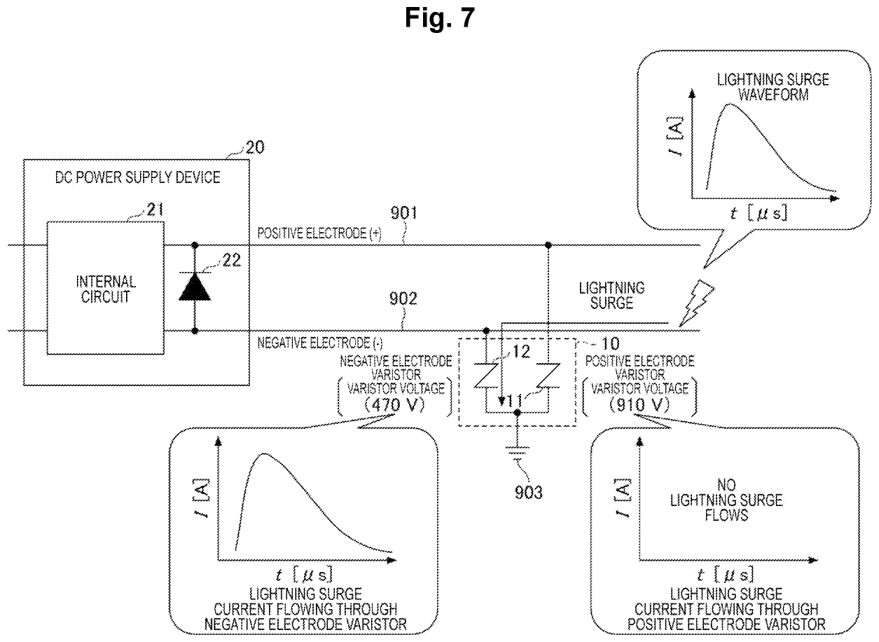

FIG. 7 is a fourth diagram illustrating a case where a lightning surge enters only into the negative electrode of the DC power supply device including the electronic element or electronic circuit having the rectification action. FIG. 7 illustrates a lightning surge current flowing through each varistor in a case where the operating voltage of the positive electrode varistor 11 and the operating voltage of the negative electrode varistor 12 have an extremely large difference (e.g. the operating voltage of the positive electrode varistor 11 is 910 V, and the operating voltage of the negative electrode varistor 12 is 470 V). When an extremely large difference is made between the operating voltages, only the negative electrode varistor 12 functions. This makes it possible to cause almost all the entered lightning surge to flow to the negative electrode. Therefore, the lightning surge current hardly flows through the diode 22, which makes it possible to prevent the failure of the DC power supply device 20.

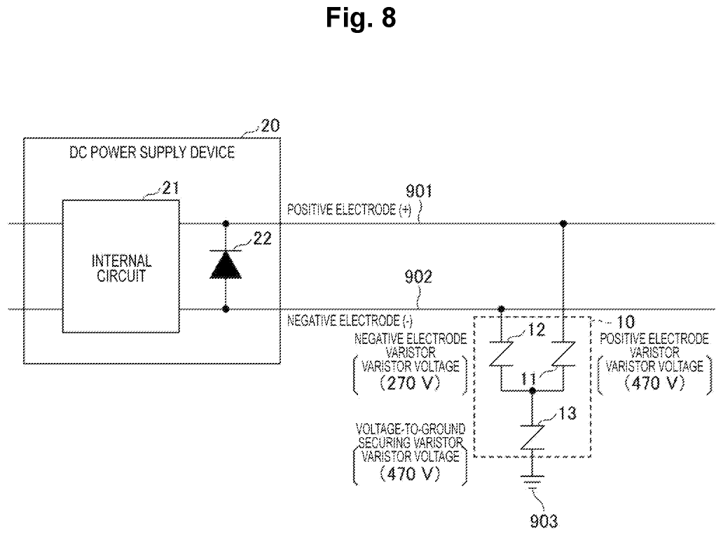

FIG. 8 illustrates a method of securing a maximum allowable circuit voltage between the lines. The positive electrode varistor 11 and the negative electrode varistor 12 cannot freely lower their operating voltages because a maximum allowable circuit voltage for the varistors to operate in normal operation is set. The maximum allowable circuit voltage is determined on the basis of an output voltage of the DC power supply device 20.

Therefore, in order to secure a voltage to ground, as illustrated in FIG. 8, the lightning protection device 10 includes a voltage-to-ground securing varistor 13 between the positive and negative electrode varistors 11 and 12 and the ground point 903. This makes it possible to secure the maximum allowable circuit voltage with respect to the ground and between the lines. The voltage-to-ground securing varistor 13 is an example of a voltage-to-ground securing arrester (lightning arrester element or lightning arrester circuit) for securing the voltage to ground.

Next, a method of calculating an appropriate value as a difference in operating voltage between the positive electrode varistor 11 and negative electrode varistor 12 will be described.

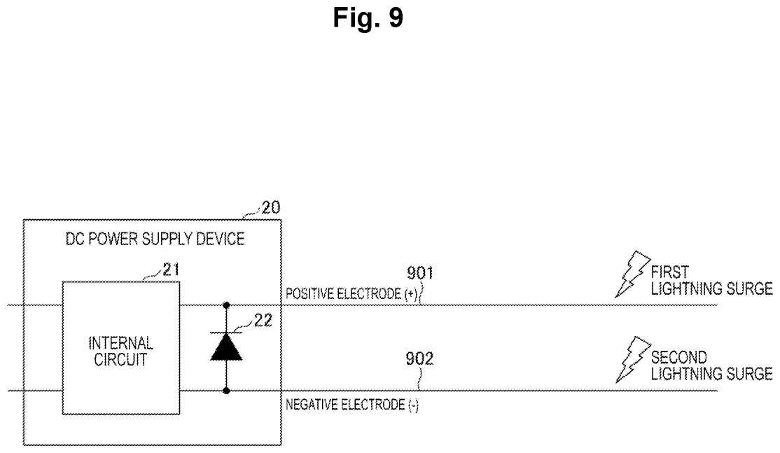

FIG. 9 illustrates a method of calculating the difference in operating voltage. The method in FIG. 9 is an example of a method of calculating an appropriate value as the difference in operating voltage by performing a test of generating a lightning surge. An assumed lightning surge (e.g. combination waveform or 10/350 ms waveform) is applied to the DC power supply device 20 to be protected as follows.

First, a lightning surge (first lightning surge) is applied to the positive electrode by gradually increasing a level thereof from a low level, and a level at which a failure occurs is defined as an operating voltage V(+).

Second, a lightning surge (second lightning surge) is applied to the negative electrode by gradually increasing a level thereof from a low level, and a level at which a failure occurs is defined as an operating voltage V(−).

Third, a difference V(diff) in operating voltage is calculated by the following Equation 1.

$$V ( diff ) = V ( + ) - V ( - ) \qquad ( Equation 1 )$$

Alternatively, instead of performing the test, the appropriate value as the difference in operating voltage may be calculated from a withstand voltage of the diode 22.

For example, the difference V(diff) in operating voltage is determined on the basis of the withstand voltage V(d) of the diode by the following Equation 2. Here, a denotes a coefficient of 1 or less.

$$V ( diff ) = a \times V ( d ) \qquad ( Equation 2 )$$

Further, both a result of the test and the withstand voltage of the diode 22 may be considered. For example, the difference V(diff) in operating voltage is determined by the following Equation 3.

$$V ( diff ) = [ a \times V ( d ) + b \{ V ( + ) - V ( - ) \} ] / 2 ) \qquad ( Equation 3 )$$

### (Configuration of Lightning Protection Device According to Present Embodiment)

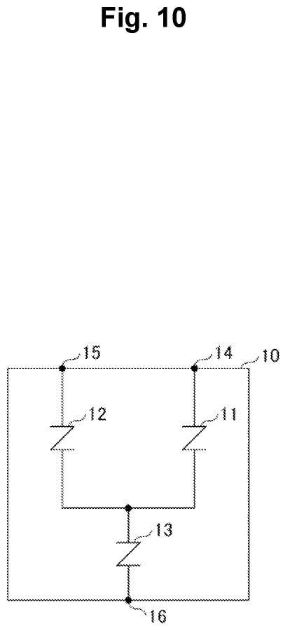

FIG. 10 is a first diagram illustrating an example of a configuration of the lightning protection device according to the present embodiment. Based on the above consideration, the lightning protection device 10 according to the present embodiment includes the positive electrode varistor 11, the negative electrode varistor 12, the voltage-to-ground securing varistor 13, a positive electrode terminal 14, a negative electrode terminal 15, and a ground terminal 16.

The operating voltage of the positive electrode varistor 11 is higher than the operating voltage of the negative electrode varistor 12. When the difference V(diff) or the like determined by the above calculation method is used as a reference value, the difference in operating voltage may be, for example, a difference equal to or more than the reference value.

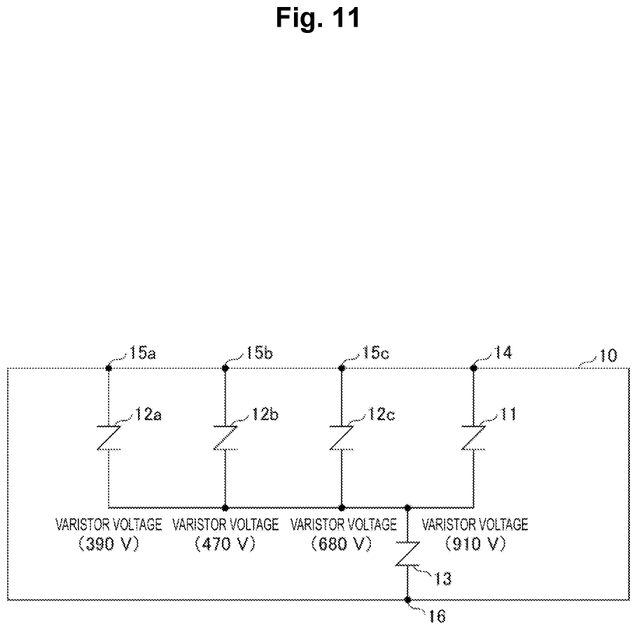

FIG. 11 is a second diagram illustrating an example of the configuration of the lightning protection device according to the present embodiment. The lightning protection device 10 includes the positive electrode varistor 11 (e.g. the operating voltage of 910 V), a plurality of negative electrode varistors, the voltage-to-ground securing varistor 13, the positive electrode terminal 14, a plurality of negative electrode terminals, and the ground terminal 16.

The plurality of negative electrode varistors includes, for example, a first negative electrode varistor 12a (operating voltage of 390 V), a second negative electrode varistor 12b (operating voltage of 470 V), and a third negative electrode varistor 12c (operating voltage of 680 V).

The plurality of negative electrode terminals includes a first negative electrode terminal 15a for the first negative electrode varistor 12a, a second negative electrode terminal 15b for the second negative electrode varistor 12b, and a third negative electrode terminal 15c for the third negative electrode varistor 12c.

According to the lightning protection device 10 in FIG. 11, when the negative electrode terminal is selected depending on a device to be protected, it is possible to select the operating voltage of the negative electrode varistor.

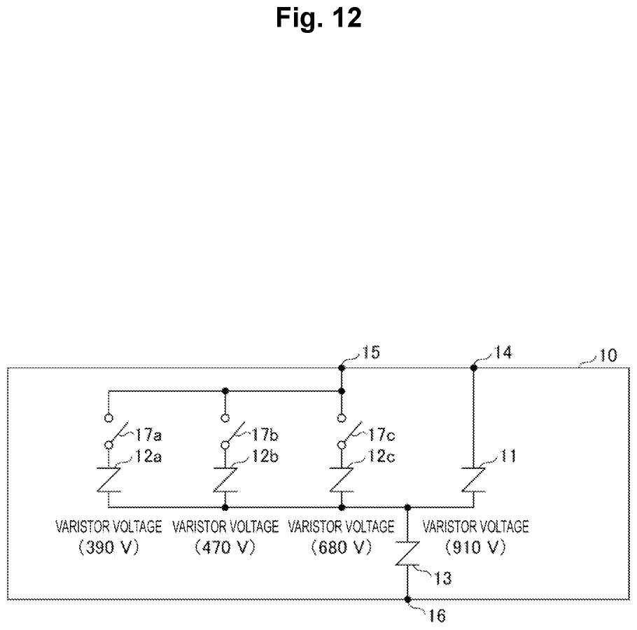

FIG. 12 is a third diagram illustrating an example of the configuration of the lightning protection device according to the present embodiment. The lightning protection device 10 includes the positive electrode varistor 11 (e.g. the operating voltage of 910 V), the plurality of negative electrode varistors, the voltage-to-ground securing varistor 13, the positive electrode terminal 14, the negative electrode terminal 15, the ground terminal 16, and a plurality of switches.

The plurality of negative electrode varistors includes, for example, a first negative electrode varistor 12a (operating voltage of 390 V), a second negative electrode varistor 12b (operating voltage of 470 V), and a third negative electrode varistor 12c (operating voltage of 680 V).

The plurality of switches includes a first switch 17a for the first negative electrode varistor 12a, a second switch 17b for the second negative electrode varistor 12b, and a third switch 17c for the third negative electrode varistor 12c.

According to the lightning protection device 10 in FIG. 12, when the switches are turned on/off depending on the device to be protected, it is possible to select the operating voltage of the negative electrode varistor.

According to the lightning protection device 10 of the present embodiment, when a difference is made between the operating voltages of the positive and negative electrode varistors 11 and 12, the negative electrode varistor 12 easily operates. This makes it possible to cause an entered lightning surge to flow not only to the positive electrode but also to the negative electrode. This reduces the lightning surge current passing through the diode 22 and thus reduces the failure of the DC power supply device 20. Therefore, it is possible to appropriately release a lightning surge to the ground even in a case where the electronic element or electronic circuit having the rectification action is provided between the lines of the DC power supply device 20.

### Summary of Embodiment

The present specification describes at least the lightning protection device and the lightning protection method described in the following items.

### (Item 1)

A lightning protection device for protecting a DC power supply device from a lightning surge current, the lightning protection device including:
a positive-electrode-side lightning arrester connected between a positive-electrode-side power cable of the DC power supply device and a ground point; and
a negative-electrode-side lightning arrester connected between a negative-electrode-side power cable of the DC power supply device and the ground point, in which
a difference in operating voltage between the positive-electrode-side lightning arrester and the negative-electrode-side lightning arrester is equal to or more than a reference value.

### (Item 2)

The lightning protection device according to item 1, further including
a voltage-to-ground securing arrester for securing a voltage between the ground and the positive-electrode-side and negative-electrode-side lightning arresters.

### (Item 3)

The lightning protection device according to item 1 or 2, in which:
the negative-electrode-side lightning arrester includes a plurality of negative-electrode-side lightning arresters having different operating voltages; and
the lightning protection device further includes a plurality of negative electrode terminals connected to the respective plurality of negative-electrode-side lightning arresters.

### (Item 4)

The lightning protection device according to item 1 or 2, in which:
the negative-electrode-side lightning arrester includes a plurality of negative-electrode-side lightning arresters having different operating voltages; and
the lightning protection device further includes a switch for each of the plurality of negative-electrode-side lightning arresters.

### (Item 5)

A lightning protection method for protecting a DC power supply device from a lightning surge current, the lightning protection method including:
connecting a positive-electrode-side lightning arrester between a positive-electrode-side power cable of the DC power supply device and a ground point; and
connecting a negative-electrode-side lightning arrester between a negative-electrode-side power cable of the DC power supply device and the ground point, in which
a difference in operating voltage between the positive-electrode-side lightning arrester and the negative-electrode-side lightning arrester is equal to or more than a reference value.

While the present embodiment has been described so far, the present invention is not limited to this specific embodiment, and various modifications and changes can be made within the scope of the present invention recited in the claims.

### REFERENCE SIGNS LIST

10 Lightning protection device
11 Positive electrode varistor
12 Negative electrode varistor
12a First negative electrode varistor
12b Second negative electrode varistor
12c Third negative electrode varistor
13 Voltage-to-ground securing varistor
14 Positive electrode terminal
15 Negative electrode terminal
15a First negative electrode terminal
15b Second negative electrode terminal
15c Third negative electrode terminal
16 Ground terminal
17a First switch
17b Second switch
17c Third switch
20 DC power supply device
21 Internal circuit
22 Diode
30 Power cable
901 Positive-electrode-side power cable
902 Negative-electrode-side power cable
903 Ground point

1. A lightning protection device for protecting a DC power supply device from a lightning surge current, the lightning protection device comprising:
a positive-electrode-side lightning arrester connected between a positive-electrode-side power cable of the DC power supply device and a ground point; and
a negative-electrode-side lightning arrester connected between a negative-electrode-side power cable of the DC power supply device and the ground point, wherein
a difference in operating voltage between the positive-electrode-side lightning arrester and the negative-electrode-side lightning arrester is equal to or more than a reference value.

2. The lightning protection device according to claim 1, further comprising:
a voltage-to-ground securing arrester for securing a voltage between the ground and the positive-electrode-side and negative-electrode-side lightning arresters.

3. The lightning protection device according to claim 1, wherein
the negative-electrode-side lightning arrester includes a plurality of negative-electrode-side lightning arresters having different operating voltages; and
the lightning protection device further includes a plurality of negative electrode terminals connected to the respective plurality of negative-electrode-side lightning arresters.

4. The lightning protection device according to claim 1, wherein
the negative-electrode-side lightning arrester includes a plurality of negative-electrode-side lightning arresters having different operating voltages; and
the lightning protection device further includes a switch for each of the plurality of negative-electrode-side lightning arresters.

5. A lightning protection method for protecting a DC power supply device from a lightning surge current, the lightning protection method comprising:
connecting a positive-electrode-side lightning arrester between a positive-electrode-side power cable of the DC power supply device and a ground point; and
connecting a negative-electrode-side lightning arrester between a negative-electrode-side power cable of the DC power supply device and the ground point, wherein
a difference in operating voltage between the positive-electrode-side lightning arrester and the negative-electrode-side lightning arrester is equal to or more than a reference value.

6. The lightning protection method according to claim 5, further comprising:
a voltage-to-ground securing arrester for securing a voltage between the ground and the positive-electrode-side and negative-electrode-side lightning arresters.

7. The lightning protection method according to claim 5, wherein
the negative-electrode-side lightning arrester includes a plurality of negative-electrode-side lightning arresters having different operating voltages; and
a plurality of negative electrode terminals is connected to the respective plurality of negative-electrode-side lightning arresters.

8. The lightning protection method according to claim 5, wherein
the negative-electrode-side lightning arrester includes a plurality of negative-electrode-side lightning arresters having different operating voltages; and
a switch for each of the plurality of negative-electrode-side lightning arresters.

9. The lightning protection device according to claim 2, wherein
the negative-electrode-side lightning arrester includes a plurality of negative-electrode-side lightning arresters having different operating voltages; and
the lightning protection device further includes a plurality of negative electrode terminals connected to the respective plurality of negative-electrode-side lightning arresters.

10. The lightning protection device according to claim 2, wherein
the negative-electrode-side lightning arrester includes a plurality of negative-electrode-side lightning arresters having different operating voltages; and
the lightning protection device further includes a switch for each of the plurality of negative-electrode-side lightning arresters.
